(19) United States
(12) Patent Application Publication
(10) Pub. No.: US 2026/0021483 A1
(43) Pub. Date: Jan. 22, 2026

(54) RAPID TEST STRIP

(71) Applicant: Quanta Vision Co., Ltd., New Taipei City (TW)

(72) Inventors: FU-AN YANG, New Taipei City (TW); YU-YU HO, New Taipei City (TW); CHIH-YI HSU, New Taipei City (TW); YA-CHIEH YU, New Taipei City (TW)

(21) Appl. No.: 19/265,030

(22) Filed: Jul. 10, 2025

(30) Foreign Application Priority Data
Jul. 16, 2024 (TW) 113126604

(51) Int. Cl. B01L 3/00

(52) U.S. Cl. CPC B01L 3/5023; B01L 2300/069; B01L 2300/0825

(57) ABSTRACT

A rapid test strip is provided, wherein the rapid test strip includes a base layer, a sample pad, a reaction pad and an absorption pad, the sample pad, the reaction pad and the absorption pad are sequentially disposed on the base layer, the sample pad is configured to absorb a sample, the sample pad includes an upstream end portion, a downstream end portion and a plurality of biomolecule labels, the upstream end portion is farther from the reaction pad than the downstream end portion, the plurality of biomolecule labels are at least disposed on the upstream end portion, and the plurality of biomolecule labels are configured to bond to a plurality of target biomolecules of the sample.

### BACKGROUND OF THE INVENTION

### Field of the Invention

The present invention relates to a test device, particularly to a rapid test strip.

### Description of the Prior Art

A rapid test strip can provide a detection result within a short time and is easy to use. It is often used for detecting drugs and viruses and is widely applied in personal self-testing, law enforcement agencies, medical institutions, workplaces, schools, and other venues.

A conventional rapid test strip includes a sample pad, a conjugate pad, a nitrocellulose membrane, and an absorption pad. The conjugate pad includes biomolecules, such as antibodies, for identifying a test subject. After being absorbed by the sample pad, the test subject flows to the conjugate pad via capillary action. The biomolecules on the conjugate pad react with the target biomolecules in the test subject and then flow to the nitrocellulose membrane, where a result may be generated for interpretation. Excess test subject is absorbed by the absorption pad. However, the conjugate pad in conventional technology is short in length, resulting in insufficient reaction time between the test subject and the biomolecules. For test subjects that require long reaction times, this can lead to poor color development on the nitrocellulose membrane and inaccurate positive/negative detection.

The present invention is, therefore, arisen to obviate or at least mitigate the above-mentioned disadvantages.

### SUMMARY OF THE INVENTION

The main object of the present invention is to provide a rapid test strip which increases the reaction time between a sample and a plurality of biomolecule labels disposed thereon.

To achieve the above and other objects, a rapid test strip is provided, wherein the rapid test strip includes a base layer, a sample pad, a reaction pad and an absorption pad, the sample pad, the reaction pad and the absorption pad are sequentially disposed on the base layer, the sample pad is configured to absorb a sample, the sample pad includes an upstream end portion, a downstream end portion and a plurality of biomolecule labels, the upstream end portion is farther from the reaction pad than the downstream end portion, the plurality of biomolecule labels are at least disposed on the upstream end portion, and the plurality of biomolecule labels are configured to bond to a plurality of target biomolecules of the sample.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a structural schematic view of an exemplary embodiment of the present invention; and

FIG. 2 is a top schematic structural view of an exemplary embodiment of the present invention.

### DETAILED DESCRIPTION OF THE PREFERRED EMBODIMENTS

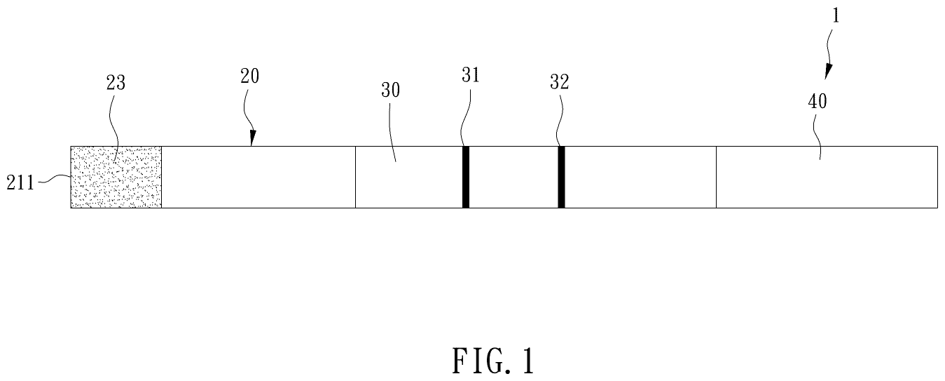

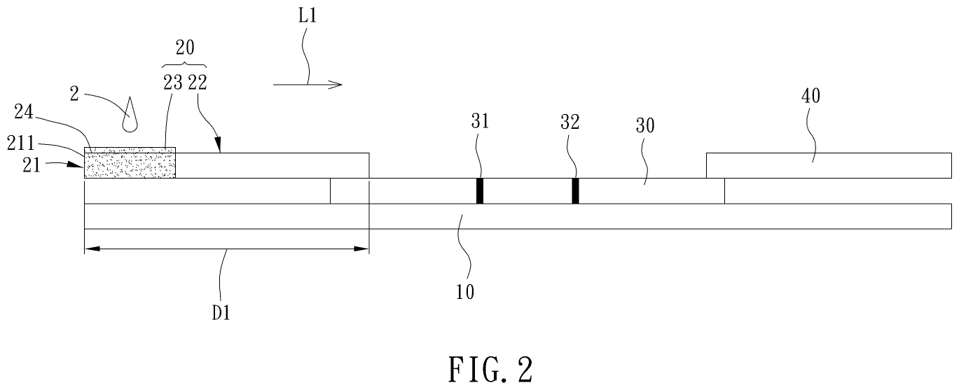

Please refer to FIGS. 1 to 2 for an exemplary embodiment of the present invention. A rapid test strip 1 of the present invention includes a base layer 10, a sample pad 20, a reaction pad 30, and an absorption pad 40.

The sample pad 20, the reaction pad 30 and the absorption pad 40 are sequentially disposed on the base layer 10. The sample pad 20 is configured to absorb a sample 2. The sample pad 20 includes an upstream end portion 21, a downstream end portion 22, and a plurality of biomolecule labels 24. The upstream end portion 21 is farther from the reaction pad 30 than the downstream end portion 22. The plurality of biomolecule labels 24 are at least disposed on the upstream end portion 21 and are configured to bond to a plurality of target biomolecules of the sample 2. In other embodiments, the downstream end portion 22 may also include the plurality of biomolecule labels 24.

The plurality of biomolecule labels 24 are a plurality of labeled antibodies or a plurality of labeled antigens. The labeled antibodies and the labeled antigens may respectively bond to conjugate gold, fluorophores or other labeling molecules.

The plurality of biomolecule labels 24 are sprayed in a solution form onto the upstream end portion 21 to form a bioreaction layer 23, so that the plurality of biomolecule labels 24 can uniformly cover the surface of the upstream end portion 21 and penetrate into the upstream end portion 21. Specifically, the sample pad 20, the reaction pad 30 and the absorption pad 40 are arranged along a first direction L1. The upstream end portion 21 includes a boundary line 211 remote from the downstream end portion 22 in the first direction L1. A distance between the bioreaction layer 23 and the boundary line 211 in the first direction L1 is less than or equal to 0.1 mm. Preferably, the bioreaction layer 23 covers the boundary line 211.

Accordingly, the sample 2 can be directly applied to the upstream end portion 21 of the sample pad 20. When the sample 2 contacts the sample pad 20, the plurality of target biomolecules immediately contact the plurality of biomolecule labels 24, increasing the reaction time between the biomolecule labels 24 and the target biomolecules, thereby providing high detection precision and color development accuracy. Specifically, the sample pad 20 provides a long reaction length D1 for the reaction between the target biomolecules in the sample 2 and the biomolecule labels 24.

Specifically, the present invention allows target biomolecules that require long reaction times, such as lipophilic hydrophobic molecules, to have sufficient time to react with the plurality of biomolecule labels 24, thereby achieving accurate color development. It is noted that the lipophilic hydrophobic molecules may include tetrahydrocannabinol (THC), but are not limited thereto.

The base layer 10 may be made of a PVC sheet or a board made of other material.

An amount of the solution containing the plurality of biomolecule labels 24 sprayed onto the upstream end portion 21 is from 5.00 μL to 20.00 μL, which enhances the intensity and accuracy of the test result.

The sample pad 20 is made of glass fiber, polyester fiber, or a combination thereof, providing good liquidity. Therefore, the sample 2 and the complex formed by the bonding of the target biomolecules and the biomolecule labels 24 are easily absorbed by the sample pad 20 and sequentially flow by capillary action from the sample pad 20 to the reaction pad 30 and the absorption pad 40.

The downstream end portion 22 is disposed above the reaction pad 30, so that the complex of the target biomolecules in the sample 2 flows onto the reaction pad 30. Specifically, the reaction pad 30 is a nitrocellulose membrane. The reaction pad 30 includes a test stripe area 31 and a control stripe area 32 sequentially arranged in a direction from the sample pad 20 toward the absorption pad 40. At least one of the biomolecule labels 24 bonds to at least one of the target biomolecules to form at least one complex. The test stripe area 31 includes a plurality of first antibodies configured to capture the at least one complex. The control stripe area 32 includes a plurality of second antibodies configured to capture at least one of the plurality of biomolecule labels 24, so that the test stripe area 31 and the control stripe area 32 can develop color and provide a basis for interpreting the test result.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rapid test strip including a base layer, a sample pad, a reaction pad and an absorption pad, wherein the sample pad, the reaction pad and the absorption pad are sequentially disposed on the base layer, the sample pad is configured to absorb a sample, the sample pad includes an upstream end portion, a downstream end portion and a plurality of biomolecule labels, the upstream end portion is farther from the reaction pad than the downstream end portion, the plurality of biomolecule labels are at least disposed on the upstream end portion, and the plurality of biomolecule labels are configured to bond to a plurality of target biomolecules of the sample.

2. The rapid test strip of claim 1, wherein the plurality of biomolecule labels are sprayed in a solution form onto the upstream end portion to form a bioreaction layer.

3. The rapid test strip of claim 2, wherein the sample pad, the reaction pad and the absorption pad are arranged along a first direction, the upstream end portion includes a boundary line remote from the downstream end portion in the first direction, and a distance between the bioreaction layer and the boundary line in the first direction is less than or equal to 0.1 mm.

4. The rapid test strip of claim 3, wherein the bioreaction layer covers the boundary line.

5. The rapid test strip of claim 2, wherein an amount of a solution containing the plurality of biomolecule labels sprayed onto the upstream end portion is from 5.00 μL to 20.00 μL.

6. The rapid test strip of claim 1, wherein the plurality of biomolecule labels are a plurality of labeled antibodies or a plurality of labeled antigens.

7. The rapid test strip of claim 1, wherein the sample pad is made of glass fiber, polyester fiber, or a combination thereof.

8. The rapid test strip of claim 1, wherein the downstream end portion is disposed above the reaction pad.

9. The rapid test strip of claim 1, wherein the reaction pad is a nitrocellulose membrane, the reaction pad includes a test stripe area and a control stripe area sequentially arranged in a direction from the sample pad toward the absorption pad, at least one of the plurality of biomolecule labels bonds to at least one of the plurality of target biomolecules to form at least one complex, the test stripe area includes a plurality of first antibodies configured to capture the at least one complex, and the control stripe area includes a plurality of second antibodies configured to capture at least one of the plurality of biomolecule labels.

10. The rapid test strip of claim 4, wherein the amount of the solution containing the plurality of biomolecule labels sprayed onto the upstream end portion is from 5.00 μL to 20.00 μL; the plurality of biomolecule labels are a plurality of labeled antibodies or a plurality of labeled antigens; the sample pad is made of glass fiber, polyester fiber, or a combination thereof; the downstream end portion is disposed above the reaction pad;
the reaction pad is a nitrocellulose membrane, the reaction pad includes a test stripe area and a control stripe area sequentially arranged in a direction from the sample pad toward the absorption pad;
at least one of the plurality of biomolecule labels bonds to at least one of the plurality of target biomolecules to form at least one complex;
the test stripe area includes a plurality of first antibodies configured to capture the at least one complex; and the control stripe area includes a plurality of second antibodies configured to capture at least one of the plurality of biomolecule labels.
